(19) United States
(12) Patent Application Publication
(10) Pub. No.: US 2024/0320918 A1
(43) Pub. Date: Sep. 26, 2024

(54) ARTIFICIAL INTELLIGENCE AUGMENTED VIRTUAL FILM PRODUCTION

(71) Applicant: ARWall, Inc., Westlake Village, CA (US)

(72) Inventors: Rene Amador, Studio City, CA (US); Leon Hui, Hawthorne, CA (US); Jocelyn Hsu, Studio City, CA (US); Danny Vargas, Temecula, CA (US)

(21) Appl. No.: 18/611,100

(22) Filed: Mar. 20, 2024

Related U.S. Application Data
(60) Provisional application No. 63/491,223, filed on Mar. 20, 2023.

(51) Int. Cl. G06T 17/20

(52) U.S. Cl. CPC G06T 17/20; G06T 13/60; G06T 15/50; G06T 2210/61; G06T 2219/2004; G06T 2219/2016

(57) ABSTRACT

A system for using generative artificial intelligence to create three-dimensional computer-generated environments for use in virtual filmmaking, the environments incorporating depth-of-field objects in the foreground, mid-ground, and background to enable virtual filmmaking to use the environment as a virtual backdrop. The system further for generating establishing and other shots through and within the computer-generated environment for use as interstitial film locations at a location associated with, similar to, otherwise alike the generated virtual locations.

### RELATED APPLICATION INFORMATION

This patent claims priority from U.S. provisional patent application Ser. No. 63/491,223 filed Mar. 20, 2023, entitled “VIRTUAL LAYERS FOR USE WITHIN A VIRTUAL FILM STUDIO”.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to an artificial intelligence augmented system for virtual film production.

### Description of the Related Art

Traditional filmmaking involves the employ of actors to act within locations, sets or real-world locations, while recording those actors on film. There are numerous complications inherent in filmmaking, such as budgetary constraints, scheduling all actors to be available for a set period of time, and finding or building relevant locations in which to capture film.

The owner of this patent has attempted to simplify some of those constraints through the use of virtual locations for filmmaking. These types of filmmaking simplify the building or access to sets or locations by enabling filming in front of a reactive, real-time rendered display that shows a virtual location. The virtual location may be created by computer software in effectively a video game engine. Computer game designers and graphic artists can create the virtual location and project it onto a large screen in a studio which may include cameras for filming the virtual location. In this way, the “location” may be built using computer software rather than physically or found in reality. Several patents owned by the assignee of this patent relate to this technology and its function.

One other aspect of filmmaking typically has employed so-called “establishing shots” which show exteriors of homes, buildings, businesses or locations to which the actors go or in which actors engage in various activities. These establishing shots show an actor's make-belief home, or the residence of a family member, or an office location or theme park. In general, establishing shots need not incorporate the actors at all, but merely set a scene for the action that will take place within that environment or in a set created to mimic that location.

Oftentimes, establishing shots are captured by a “second unit” team that goes to various locations and captures video of those exteriors or locations (e.g. a wide shot of London in the United Kingdom could be an establishing shot). Since the actors are rarely needed, the second unit team may be tasked with capturing all of those establishing shots. Similar shots demonstrating movement of a monstrous villain, for example, through a town can also be captured in a similar way, typically by a second unit.

However, the employment of an entire second unit to capture establishing shots (or similar shots) can be expensive and time-consuming. One alternative has been to employ “stock video” of exteriors of non-descript homes or locations. These stock videos tend to degrade the overall quality feel of a film because they often appear to be stock or lower quality or non-custom. But, they can be purchased for a fixed fee or license fee that is reasonable and almost always are much less than shooting one's own.

It would be beneficial if virtual production in general and the creation of exteriors, establishing shots, and the like could be automated in whole or in part to further lower the cost of production of film, without sacrificing quality.

### DESCRIPTION OF THE DRAWINGS

FIG. 1 is a diagram of a system for artificial intelligence augmented virtual film production.

FIG. 2 is a block diagram of a computing device.

FIG. 3 is a functional diagram of a system for artificial intelligence augmented virtual film production.

FIG. 4 is an example display screen of a two-dimensional image generator.

FIG. 5 is an example display screen of a two-dimensional image generator.

FIG. 6 is an example of a display screen for a three-dimensional mesh and texture generator.

FIG. 7 is an example of a display screen for a three-dimensional mesh and texture generator.

FIG. 8 is an example of a display screen for a video generator.

FIG. 9 is a flowchart of a process for two-dimensional image generation.

FIG. 10 is a flowchart of a process for three-dimensional mesh and texture generation.

FIG. 11 is a flowchart of a process for video generation.

FIG. 12 is a flowchart of a process for artificial intelligence augmented virtual film production.

Throughout this description, elements appearing in figures are assigned three-digit reference designators, where the most significant digit is the figure number, and the two least significant digits are specific to the element. An element that is not described in conjunction with a figure may be presumed to have the same characteristics and function as a previously-described element having a reference designator with the same least significant digits.

### DETAILED DESCRIPTION

Virtual film production lowers the barriers to entry for filmmaking. The use of large projection screens as virtual sets speeds production and allows sophisticated computer software to provide the setting, maintain perspective, and ensure that the experience is positive for viewers and the production team. One significant drawback of virtual production is that it has required significant skills in design of sets or locations or computer game engine understanding and art direction to create the components that make up a scene or location and to integrate them into a virtual location.

Artificial intelligence in the form of large language models (LLMs) has enabled human-like interaction with computer systems. Using LLMs, average computer users can instruct a computer to create complex objects or elements or locations or text or images or the like that conforms to certain desired qualities or traits. Accordingly, a well-trained and properly instructed artificial intelligence can be a significant aid in creating virtual locations, objects to populate that virtual location, and thereafter in creating “fly-bys,” establishing shots, or the like that conform to a created virtual location.

### Description of Apparatus

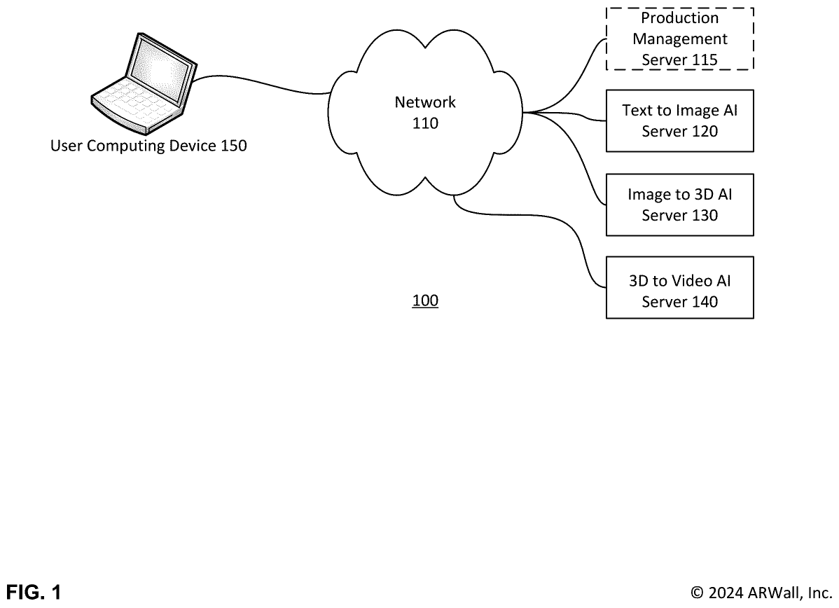

Referring now to FIG. 1, a diagram of a system 100 for artificial intelligence augmented virtual film production. The system 100 includes an optional production management server 115 (shown in dashed lines), a text to image artificial intelligence server 120, an image to three-dimensional artificial intelligence server 130, a three dimensional to video artificial intelligence server 140, and a user computing device all interconnected by a network 110.

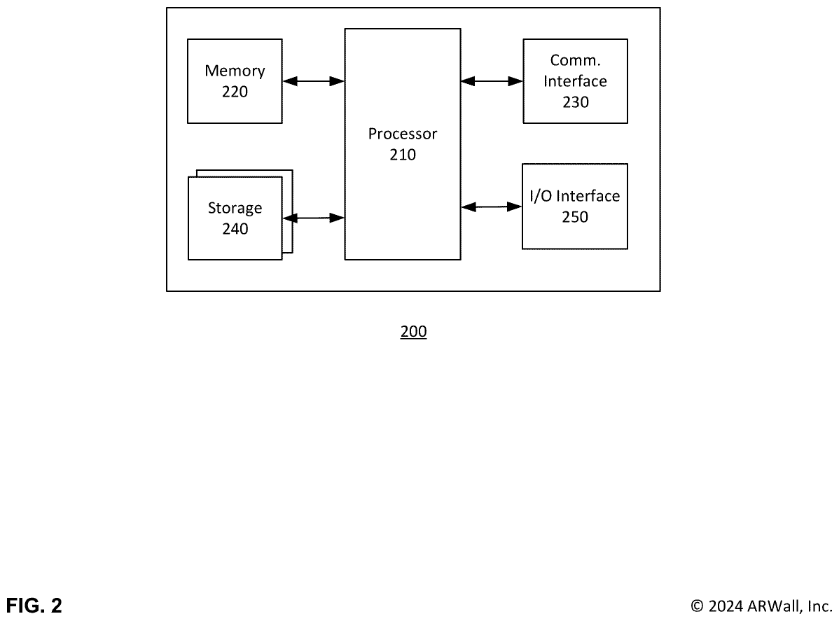

The production management server 115 is a computing device (FIG. 2) that includes software that is used to manage the overall process of artificial intelligence augmented virtual film production. The production management server 115 is optional because the system 100 may be designed in such a way that the output of each component feeds automatically into the next component and no overall production management server 115 is required for functioning. Where present, the production management server 115 may receive instructions from a user and pass those instructions on to the various other components of the system 100 and ensure that the output matches a desired input. Though shown as a single computing device, the production management server 115 may be many computing devices, a server farm, a cloud-based service or other format that may be one or many physical or virtual computing devices.

The text to image artificial intelligence server 120 is a computing device (FIG. 2) that includes software that is used to accept a text-based prompt from a user and using that prompt and some sample images as the basis of a scene image that is to be created by the overall system 100. The text to image artificial intelligence server 120 may be multiple individual computing devices, or rely upon separate LLM application programming interfaces (APIs) or otherwise utilize multiple systems to perform the functions shown herein as server 120. Though shown as a single computing device, the text to image artificial intelligence server 120 may be many computing devices, a server farm, a cloud-based service or other format that may be one or many physical or virtual computing devices.

The image to three-dimensional artificial intelligence server 130 is a computing device (FIG. 2) that includes software that is used to convert an image to a three-dimensional environment including appropriate meshes and textures for that environment and potentially including objects within that environment. This server 130 may accept additional text prompts to direct the overall system 100 and the server 130 in alterations of the image to three-dimensional artificial intelligence server 130. The server 130 may be multiple individual computing devices, or rely upon separate LLM application programming interfaces (APIs) or otherwise utilize multiple systems to perform the functions shown herein as server 130. Though shown as a single computing device, the server 130 may be many computing devices, a server farm, a cloud-based service or other format that may be one or many physical or virtual computing devices.

The three-dimensional to video artificial intelligence server 140 is a computing device (FIG. 2) that includes software that is used to accept a text based prompt and utilize the three-dimensional environment and objects to generate desired shots in video form within the environment. The server 140 may generate multiple shots and may be required to generate additional portions of the three-dimensional environment in order to capture certain shots. The server 140 may be multiple individual computing devices, or rely upon separate LLM application programming interfaces (APIs) or otherwise utilize multiple systems to perform the functions shown herein as server 140. Though shown as a single computing device, the text to image artificial intelligence server 140 may be many computing devices, a server farm, a cloud-based service or other format that may be one or many physical or virtual computing devices.

The user computing device 150 is a computing device (FIG. 2) that includes software that is used to enable a user to input text-based prompts and interact with the system 100. This may be web-based software such as a web browser or may be custom software designed specifically for the purpose of controlling or operating workflows associated with the system 100.

The network 110 is or may include the internet. The network 110 is one or more interconnection systems or protocols that enable data communication between the various computing devices described herein.

Turning now to FIG. 2 there is shown a block diagram of a computing device 200, which is representative of the camera 110 (in some cases), the workstation 120, and the trackers 112, 142, and 144 (optionally) in FIG. 1. The computing device 200 may be, for example, a desktop or laptop computer, a server computer, a tablet, a smartphone or other mobile device. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor 210 may be or include one or more microprocessors, specialized processors for particular functions, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210. As used herein the term “memory” corresponds to the memory 212 and explicitly excludes transitory media such as signals or waveforms.

The storage 214 provides non-volatile, bulk or long-term storage of data or instructions in the computing device 200. The storage 214 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the terms “storage” and “storage medium” explicitly exclude transitory media such as signals or waveforms. In some cases, such as those involving solid state memory devices, the memory 212 and storage 214 may be a single device.

The network interface 216 includes an interface to a network such as network 150 (FIG. 1). The network interface 216 may be wired or wireless.

The I/O interface 218 interfaces the processor 210 to peripherals (not shown) such as displays, video and still cameras, microphones, keyboards and USB® devices.

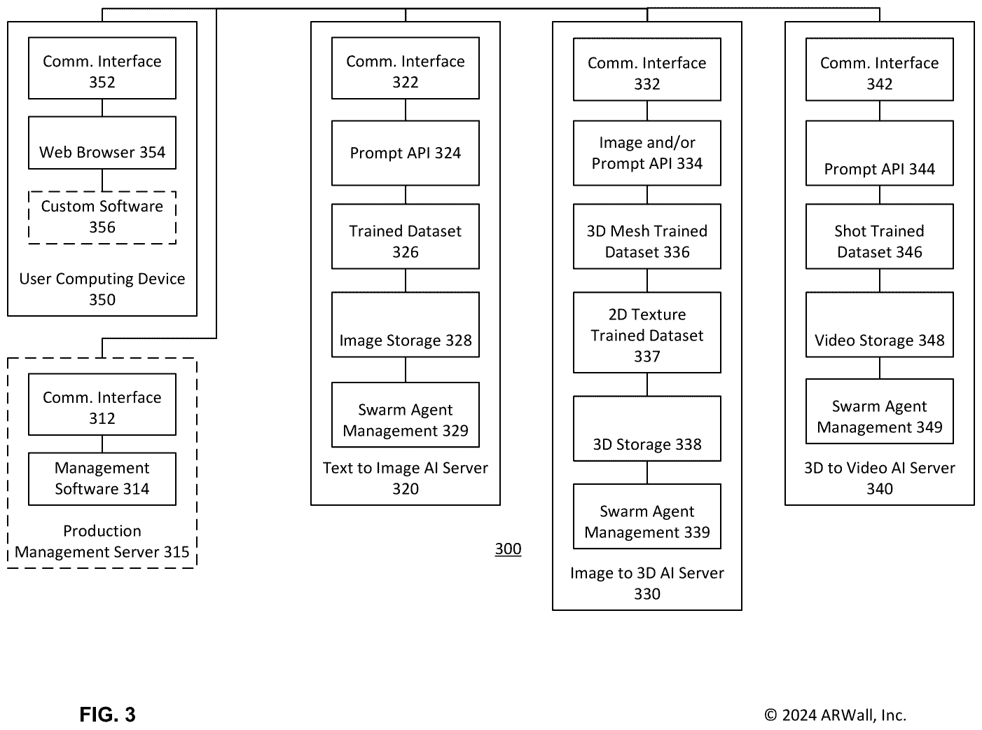

FIG. 3 is a functional diagram of a system 300 for artificial intelligence augmented virtual film production. The system 300 includes an optional production management server 315, a text to image AI server 320, an image to three-dimensional AI server 330, a three-dimensional to video AI server 340, and a user computing device 350. Each component of the system 300 is responsible for different functions within the overall system.

The optional production management server 315 is shown in dashed lines to indicate that it may or may not be present in the system. If present, the server 315 includes at least two functional components (others may be present), the communications interface 312 and the management software 314.

The communications interface 312 is responsible for enabling communication between the production management server 315 and the other components of the system 300. The communications interface 312 may include traditional networking functions such as TCP/IP communications, wireless 802.11x or ethernet functions, but may also include custom software or software front-ends suitable for interacting with the various components of the system 300. In general, the production management server 315 will interact using the communications interface 312 with all of the other components of the system 300.

Likewise, the production management server 315, the text to image AI server 320, the image to three-dimensional AI server 330, the three-dimensional to video AI server 340 and the user computing device 350 each include a communications interface 312, 322, 332, 342, and 352, respectively. Each of the communications interfaces 312, 322, 332, 342, and 352 are responsible for enabling each of the devices or components of the system 300 to communicate data with the others. The communications interfaces 312, 322, 332, 342, and 352 may be implemented in software with some portion of their capabilities carried out using hardware. The communications interfaces will not be discussed independently below unless it is to discuss their differences.

The management software 314 is represented as a monolith, but may in fact be multiple hardware or software systems or modules. The management software 314 is responsible for managing the interactions of the other server(s) within the system 300 to ensure the overall system 300 is working properly. In some instances, this software 314 may operate as a plurality of instances operating in a swarm function to repeatedly and slightly-differently seek the same outcome, and thereafter to select the best-suited from among those outcomes. This type of swarm agent functionality has been shown to provide better results from AI (artificial intelligence) systems reliant upon natural language models. Such systems can have nonsensical results or less-than-ideal results sometimes, but when running a query, prompt, or otherwise responding to a request, large language models (LLMs) can output excellent results and less-excellent results. Then, the same LLM or another can be employed to evaluate the results for desired characteristics and choose those that seem best with no or limited human input before presenting those results to a human for consideration.

The management software 314 may perform swarm agent like behavior to respond to prompts input by users or to request multiple output options, review them, and manage the output of each of the other servers in the system 300 to ensure the process overall runs well and provides the desired output and results.

The management software 314 may also be responsible for accepting a text-based prompt and other input (e.g. images) from a user to begin the process. Or, at intervals between operation of each of the servers 320, 330, 340, the management software 314 may enable input by a user in the form of a prompt or partial prompt wherein the user can request alterations, slight changes, different coloration, etc. for the desired output of each of those servers 320, 330, 340. In other cases, user interaction may be minimized (e.g. to decrease complexity for a user, likely at the expense of precision) and the management software 314 may itself try best to manage each portion of the overall process to ensure that output adequately matches the user's input and to select from among the various swarm agents' output.

The text to image AI server 320 performs the process of receiving a user text-based prompt and/or input sample images and applying generative AI to create one or more images in proper scale that incorporate the desired elements, objects, and “feel.” So, for example, a postcard of a desert scene or picture may be uploaded along with images of a 1950s-era car and a space suit. The text prompt may be “create a scene including this car and a person in a space suit within a desert setting.” The resulting output may be a plurality of images of a desert scene incorporating a person in a space suit in the car, near the car, and with cactus and various other objects that might appear in such a scene. The output preferable is a unified image or images with proper scale (e.g. the car is of a size within the image that the human could sit inside or drive it). Those images may be used by the image to three-dimensional AI server to create three-dimensional meshes and textures (discussed below).

The text to image AI server 320 incorporates a prompt API 324, a trained dataset 326, image storage 328, and swarm agent management 329.

The prompt API 324 is a text-based prompt input and/or chat feature that enables a user (or the production management server 315) to input a text-based prompt and/or concept art in the form of .jpg, .png, .pdf, .mp4, an online video link, or the like so that the text to image AI server 320 may generate the desired scene image(s). The prompt API 324 may incorporate an actual chat window in a web browser (e.g. web browser 354 of the user computing device 350) or available to a user using custom software 356. Or, the prompt API 324 may be an API interface used by the management software 314 to accept input from a user and/or the production management server 315 to generate the desired images. The prompt API 324 may communicate or be integral to a generative AI system suitable for converting a text-based prompt and/or example images into an integrated image of a suitable scale. In general, the generative AI system may be publicly-available system (as discussed below), but in other cases, the generative AI system may be integral to the server 320. The prompt(s) and image(s) input by a user using the prompt API 324 may be augmented through the use of a plugin and/or an augmented prompt (e.g. inserting further instructions into a prompt or materials) to instruct a generative AI in creating a response in a desired format.

The trained dataset 326 is a dataset used by generative AI to receive input in text and/or image (or video) form and to use that input to generate appropriately scaled images in response. The trained dataset 326 is typically trained on a large dataset of to-scale images to “learn” what is an appropriate scale for most objects. In addition, the trained dataset 326 may be trained on a database including text labels or identification for many or most objects within or present within each image. In this way the generative AI can learn to identify objects and to recognize their usual scale relative to other objects.

This trained dataset 326 may be particularly trained on a smaller dataset related to other virtual locations used in virtual production. The dataset 326 may then be particularly useful for generating output in a format desired or useful to the image to three-dimensional server 330 (discussed below). A preferable format for output of the properly scaled image, as taught by the types of three-dimensional virtual locations desirable for use in creating those virtual locations preferably will have a number of attributes:

Such an image will be two-dimensional and have a one-hundred eighty (180) degree field of view. So, the image will be a broad perspective, not a macro-style close-up, or only a partial scene. Preferably, the two-dimensional image(s) will look to be a full scene or backdrop already. Such an image will preferably be level to the horizon (e.g. not at an angle or otherwise tilted). A desirable image will not contain solid black areas (e.g. shadows or deep distances) or very bright locations (e.g. direct sunlight) or otherwise incorporate indistinct areas. Such an image will have a neutral tone for its color tone. Having that type of image enables filmmakers to use traditional filters (digital or physical) to create a desired tone for the resulting image.

A desirable image will be very high pixel density (e.g. at or greater than so-called 8K images at 7680×4320 pixels). The high pixel density and/or resolution ensures that there is no “blurriness” that the subsequent steps must accommodate or create. A desirable image should appear “natural” incorporating none of the oddities of generative AI images. These can be hands in unusual poses, legs bent or curved, unusual text or labels that are unnecessary. Various types of AI artifacts are possible, dependent upon the training data used.

Most importantly, a desirable image will have each object within the image properly scaled in 1:1 sizing for real-life objects corresponding to the image. This includes scaling appropriate for distances (e.g. a full-grown tree far in the background should appear much smaller than a human, though humans are typically much smaller than full-grown trees). In this way, subsequent application of image-based AI can easily determine which objects are close to the virtual “camera” (foreground) and which objects are mid-ground and which objects are background, reliant upon the scaling used.

The artificial intelligence itself is not disclosed as a part of the text to image AI server 320. The communications interface 322 is used to enable the server 320 to interact with an external generative AI to perform the functions discussed herein. However, in some cases the generative AI may be or may make up a part of the trained dataset 326. Or, alternatively, the trained dataset 326 may be replaced by the generative artificial intelligence system itself which includes a trained dataset like trained dataset 326. But, in the present state of the art, it is most efficient to rely upon large-scale publicly-available artificial intelligence systems and to integrate specialized “plugins” and/or datasets and/or detailed prompt instructions to utilize those generative AI systems to function as desired. Those publicly-available generative AI systems typically can draw upon much larger training datasets and provide better results than those with small datasets. Nonetheless, in the future it may be preferable to have a carefully trained generative AI that is applicable or used only in providing these types of responses to a specific set of inputs. Over time, such a special purpose generative AI may become much better at performing its task than a more general-purpose generative AI available publicly. In such a case, the trained dataset 326 may be replaced with an independent generative AI within the text to image AI server 320.

The image storage 328 is a database and associated hardware storage for storing the resulting images that are output by the generative AI. The image storage 328 is particularly helpful in the application of swarm agents and enabling the generative AI to “remember” the data (e.g. images) that are created as a part of this process to enable subsequent interaction with those images. For example, a filmmaker could return to the dataset and suggest minor revisions to one of the many iterations by swarm agents to make a particular image or set of images better-suited to a desired purpose. This interaction may be enabled by a chat-bot like interface and access to a library of previously-created images in the image storage 328.

The image storage 328 also stores associated metadata for the created images along with the images it creates. That metadata may identify the various objects (and their locations in the image), the scale of the objects relative to a fixed measurement (e.g. inches, meters, centimeters, etc.) and/or relative to a desired three-dimensional engine's scale, and any lighting properties (e.g. the three-dimensional location of one or more lights, their brightness, their distance from objects). This metadata may be used by the image to three-dimensional AI server 330 to aid in performing its functions.

The swarm agent management 329 is software that requests the server 320 to perform its functions using generative AI over many iterations. The swarm agent management 329 alters, either randomly or iteratively, the prompts and the substance of the prompts, and may be informed by the output image(s) in the interim, to iteratively or simply brute-force its way to the best possible output. The swarm agent management 329 may apply tens, hundreds, or thousands of iterations or simultaneously-executed prompts and outputs from generative AI to create tens, hundreds, or thousands of options for appropriate images in response to the prompt and source images.

The swarm agent management 329 may itself be or integrate access to generative AI wherein it can be employed to compare the prompt and the output images and to automatically select those image(s) or groups of images that best-match the result, best have the desired characteristics of output (identified above), or that otherwise seem best suited to the purposes of the overall system 300. The swarm agent management 329 may work autonomously (e.g. without any direction other than the initial prompt) or may operate as directed by the management software 314 and/or a user.

The image to three-dimensional AI server 330 is responsible for receiving one or more images, which may include objects or backgrounds and outputting a three-dimensional mesh (e.g. triangle-based mesh for use with game engines) and associated textures for use on that mesh. The resulting combination of the mesh and the textures using three-dimensional modelling software and/or game engine-like software will create a three-dimensional computer-generated environment which may serve as a backdrop/virtual location for a virtual film production. The image to three-dimensional AI server 330 can also accept text prompts and/or text guidance to alter or slightly-change the resulting meshes and/or textures.

The image to three-dimensional AI server 330 includes an image and/or prompt API 334, a three-dimensional mesh trained dataset 336, a two-dimensional texture trained dataset 337, three-dimensional storage 338, and swarm agent management 339.

The image and/or prompt API 334 performs a similar function to prompt API 324. Here, the image and/or prompt API 334 accepts input of the images of a virtual location in the format described above and generated by the text to image AI server 320. The prompt instructs the sever 330 in how it is to perform its function of creating appropriate meshes and textures. The prompt may be integrated with an API or otherwise communicate using an API with an independent, suitable generative AI system or systems for generating three-dimensional environments. In some cases, more than one generative AI system (e.g. for different output types) may be used as discussed below.

The input images are two-dimensional and have some or all of the attributes described above for such images. The text-based prompt is optional, but may provide additional guidance for the server 330. For example, an image or a plurality of images in the desired format may be uploaded to a web service location or to the image to three-dimensional AI server 330 itself and an associated prompt may ask that the server 330 “create a first perspective of this scene with a cactus in the background, and the sun high in the sky and create a second, opposite perspective of this scene with a car in the mid-ground and a road leading off in to the distance.” This type of additional text-based prompt may provide more information on desired outputs for the server 330 than merely the images alone. In other cases, the image or images alone may be the only input via the image and/or prompt API 334.

The three-dimensional mesh trained dataset 336 is a generative AI dataset that is trained on input two-dimensional images that may be constrained to the characteristics described above with respect to the output of the text to image AI server 320 and corresponding three-dimensional meshes for objects present within such images. In this way, this dataset 336 may be used by generative AI to create appropriate meshes based upon similar input two-dimensional images.

The two-dimensional texture trained dataset 337 is a generative AI dataset that is trained on input two-dimensional images that may be constrained to the characteristics described above with respect to output of the text to image AI server 320 and corresponding three-dimensional textures for objects present within such images. The two datasets 336, 337 may be co-trained since the textures must suitably match the associated textures. These textures may be “wrapped” onto the associated meshes for objects within the scene or virtual location to enable the creation of a three-dimensional computer generated environment that may stand in as a virtual location.

Both the three-dimensional mesh trained dataset 336 and the two-dimensional texture trained dataset 337 are shown as integral to the server 330, but the generative AI itself is not. As with the server 320, the use of publicly-available generative AI systems and their associated APIs is presently preferred. However, in the future, single purpose or generative AI systems integral to the server 330 may be better or more desirable in certain situations.

The generative AI (integral or external to the system and communicated with via the communications interface 332) may be instructed through plugins, detailed prompts or otherwise to detect within the images certain characteristics that will enable it to better-create suitable virtual locations in the form of computer-generated three-dimensional environments. The generative AI may be instructed to identify within the images (and potentially reliant upon the associated metadata) certain characteristics and to output.

As with the images output by the text to image AI server 320, the output of the image to three-dimensional AI server 330 may output its three-dimensional environment subject to certain constraints or incorporating certain characteristics as directed by augmented prompts (e.g. edits made automatically to a prompt input by a user) or as directed by a plugin or the training itself. The generative AI may be instructed to differentiate between foreground objects (e.g. objects close to human scale and near to the viewer (e.g. a camera position within the three-dimensional environment) which should be generated with very high quality textures since they will be closest to the virtual camera, midground objects in the middle background with middle quality textures since they will be further away from the virtual camera, and background objects which may be simply a skybox or may also have some elements of depth differentiating from, for example, sky, building or trees, landmarks, or the like in the background.

In addition, the output may be formatted to include lightmaps, to incorporate proper lighting for all objects within the virtual environment generated by the server 330. The lighting may be precomputed to be at a fixed position within the virtual environment or may be added to the texture maps themselves so as to maintain uniformity with use of less computational power. As a result, for lighting other than sunlight or a single source light from some distance, the locus in which a virtual camera can move while retaining proper lighting may be more limited than for precomputed lighting which may alter or be updated based upon camera position and/or light position changes within the virtual environment.

The output meshes and textures of the server 330 may be formatted to enable virtual camera movement within a pre-determined diameter or space, for example, to be movable within a 15 foot radius around a center point. In some cases, only a 180 degree view of a scene may be generated (e.g. one perspective on a location), while in other cases, a 360 field of view for a spherical area of a certain radius may be created in three dimensions (meshes and textures) so that a virtual camera (corresponding to a real camera at a corresponding position) may be placed at any location within the space and able to film in any direction. In other cases, larger environments may be created so that a virtual (and actual) camera may be placed at any position within that space or predefined areas within the virtual space to film from multiple positions within the environment.

In each case, the server 330 may only generate textures and appropriate meshes for positions from which the camera will be able to film or move. In this way, memory and computational resources will be lessened by not texturing the “back” of three-dimensional objects within the scene that will never be visible to the camera. But, the camera will be able to move within the scene (e.g. in front of one or more displays showing portions of the computer-generated virtual location) in those constrained areas without fear of missing textures or three-dimensionality of objects or the space itself.

The generative AI trained datasets 336, 337 may also be trained on three-dimensional environmental spaces that incorporate particle effects, fluid effects, weather, destructible environmental elements, and other non-rigid environmental elements (e.g. flags waving, trees and shrubs moving in wind, etc.) so that resulting virtual locations or environments of textures and meshes generated using the trained datasets 336, 337 may likewise incorporate non-rigid elements natively. So, for example, if the input image incorporates a flag or logo on a flag, a three-dimensional mesh and texture for that flag may automatically be detected as a flag and incorporate non-rigid behavior (e.g. flapping in the wind). Likewise, water which moves naturally in reality, and may be trained from water elements in previously-created virtual environments, may automatically be identified as “water” in metadata and/or by the generative AI detecting as much and may be made to incorporate water physics for the three-dimensional computer game engine like software or other three-dimensional environment creative system.

Similarly, particle effects like smoke or dust may be employed in similar fashion such that an image depicting a desert environment may automatically cause the generative AI to generate particle effects of dust or sand in the air. Or, for an industrial environment to automatically generate smoke or steam effects for certain elements of the resulting three-dimensional environment. Outdoor environments shown in images (or based upon user text-based prompt) may be detected as “gloomy” or “raining” and integrated visual effects for raindrops and puddles and the like may be added to a three-dimensional environment automatically by the generative AI.

The three-dimensional storage 338 is a database and hardware storage for storing the resulting three-dimensional meshes and associated textures for each aspect of a three-dimensional computer-generated environment created by the server 330. The three-dimensional storage may enable the server 330 to repeatedly iterate on the concept present in the prompts and/or images provided to the image and/or prompt API 334. In addition, the three-dimensional storage 338 enables the production management server 315 or a user to identify particular outputs at a later time or soon after their creation, and to request major or minor changes using a chat-box like interface or other API 334 for the generative AI. In this way, subtle or non-subtle changes may be made to a particular set of meshes and textures without resorting to completely re-making the elements.

The swarm agent management 339 is responsible for iteratively or serially making the same prompts or subtly or drastically different prompts to try and create a best option for the output based upon the images and/or prompt provided by the user and/or the production management server 315. In addition, the swarm agent management 339 may allocate different processes for each element of the three-dimensional model to be created. So, for example, foreground objects may be processed through a tool suited for generating discrete rigid objects for close view, whereas midground objects may be processed with a tool for creating 3D environments, and background objects could be processed into a tool that generates a skybox/lightingbox/HDRI/360-photo. Likewise, particle effects or non-rigid effects may be processed through a different tool for adding such elements to an environment. Yet another swarm agent could be tasked with recoalescing the elements generated by the other tools into a cohesive scene or three-dimensional environment including a matching color temperature, style, and scale.

The resulting output, stored in three-dimensional storage, preferably includes three-dimensional geometry in the form a three-dimensional mesh or model, textures for each mesh, and precomputed lighting, integrated lighting (e.g. into the texture itself) and an identification of directionality (e.g. an identification of valid camera positions) for each three-dimensional virtual location created by the server 330. In this way, a resulting three-dimensional virtual location (e.g. a computer generated three-dimensional virtual environment) is essentially ready for filming upon completion of operation of this server 330.

In some cases, user edits may be desirable or required before filming can begin. The resulting output meshes, textures, lighting information, and camera directionality information will be stored in formats that are available for user editing using typical three-dimensional computer graphical tools such as Unity® engine, Unreal® engine or other, similar computer three-dimensional graphics tools for editing models and three-dimensional environments.

The three-dimensional to video AI server 340 is responsible for receiving a three-dimensional mesh and associated two-dimensional textures along with a prompt or other direction describing a desired shot within the virtual location created by the three-dimensional mesh and two-dimensional textures and outputting such a shot conforming to the desired output. In some cases, this may require generation of more of the three-dimensional computer-generated environment than was previously-available following operation of server 330. In other cases, it may not. The output shots maybe “fly by” shots, establishing shots, exterior shots that correspond to a virtual interior location, overhead shots of a city, town, exterior, tracking shots moving to or through a location, or the like. The prompt itself will identify the desired shot and the server 340 will output the desired shot based upon the input mesh and textures and that prompt.

The three-dimensional to video AI server 340 includes a prompt API 344, a shot trained dataset 356, video storage 348, and swarm agent management 349.

The prompt API 344 is an API for accepting text-based prompts, and potentially example shots in the form of video prompts, for a desired shot to be created by the three-dimensional to video AI server 340. The prompt API 344 may also begin with accepting the three-dimensional environment created by the image to three-dimensional AI server 330 which forms the basis of the three-dimensional environment through which the shot may move. The prompt may be parsed (e.g. by a plugin or through augmentation with additional parameters for how to perform the desired video shot) before being provided to a suitable generative AI system which, as described above, is generally a publicly-available service, but in some cases may be integral or separate from the system 300.

The shot trained dataset 356 is a generative AI dataset that has been trained on combinations of three-dimensional environments and resulting output “shots” or video captures of that three-dimensional environment and/or real-world shots captured by filmmakers of the types desired by filmmakers. Metadata naming (e.g. identifying the particular shot by name or names, locations, and the like) can be used to better-enable the generative AI and shot trained dataset 356 to operate to create a plurality of desired shot types. In this way, the generative AI can learn an association of a particular request, e.g. for an establishing shot, a panning shot, an overhead view, a city skyline view, etc., to a particular type of shot. Thereafter, the shot trained dataset 356 can be used by generative AI to create an appropriate shot.

The video storage 348 stores the output of the three-dimensional to video AI server 340. The video storage may store desired shots along with metadata in a database and hardware storage suitable for storing such elements. The prompt API 344 may enable users to request tweaks or changes to the resulting video stored in video storage 348. To enable that functionality or the capability to return to eh resulting images many days or weeks or months later for small changes (e.g. while in editing or post-production), the video storage 3348 may remember users who interact with the prompt API 344 and enable them to request such changes while maintaining the various iterations of options for associated shots.

As with the images and three-dimensional meshes and textures created by the system 300, the shots preferably have certain characteristics. Preferably the output is of a resolution approaching or at so-called 8k (7680×4320 pixels). It is also preferable that the resulting videos are within the same environment generated by the image to three-dimensional AI server 330 for the associated production. It is preferable that the resulting videos are of one or more known types (e.g. master shots, establishing shots, vehicle exterior shots, etc.). It is preferable that the same elements from the three-dimensional environment generated by the image to three-dimensional AI server 330 are present (e.g. any motion, vehicles, people, weather, particle or non-rigid objects, and other objects). It is preferable that further text-based prompts can be used to further revise the shots generated.

The swarm agent management 349 operates in conjunction with user input to the prompt API 344 and/or the production management server 315's management software 314 or in some cases entirely autonomously to iterative and in parallel to create numerous options for the requested shot and to, thereafter, evaluate the resulting output for the result that is most-desirable. A separate generative AI may evaluate the results and may even autonomously request further revisions or changes to the output. The swarm agent management 349 operates to orchestrate this process.

The user computing device 350 is a typical computing device operating software that enables it to interact with the other components of the system to generate three-dimensional environments and video using the servers 320, 330, and 340, which may be operated under the direction of the production management server 315.

The user computing device 350 includes a web browser 354 and may optionally include custom software 356.

The web browser 354 is software operating on the user computing device 350 that enables web browsing. Typical software includes programs like Mozilla® Firefox® web browser or the Microsoft® Edge® browser or Google® Chrome browser. However, the web browser 354 may instead be or be built into other software, such as video editing software, filmmaking software, computer graphics modelling software, or other video creation software.

The custom software 356 is yet another option for the user computing device 350. It is an optional component, presented in dashed lines. The custom software 356 may be an entirely custom software that includes the capability to request AI generated elements created by the various servers 320, 330, and 340. Or, the custom software 356 may be built into other software such as video editing software or filmmaking or creation software. In such a case, the user computing device 350 may perform all of the functions of the production management server 315.

### Description of Processes

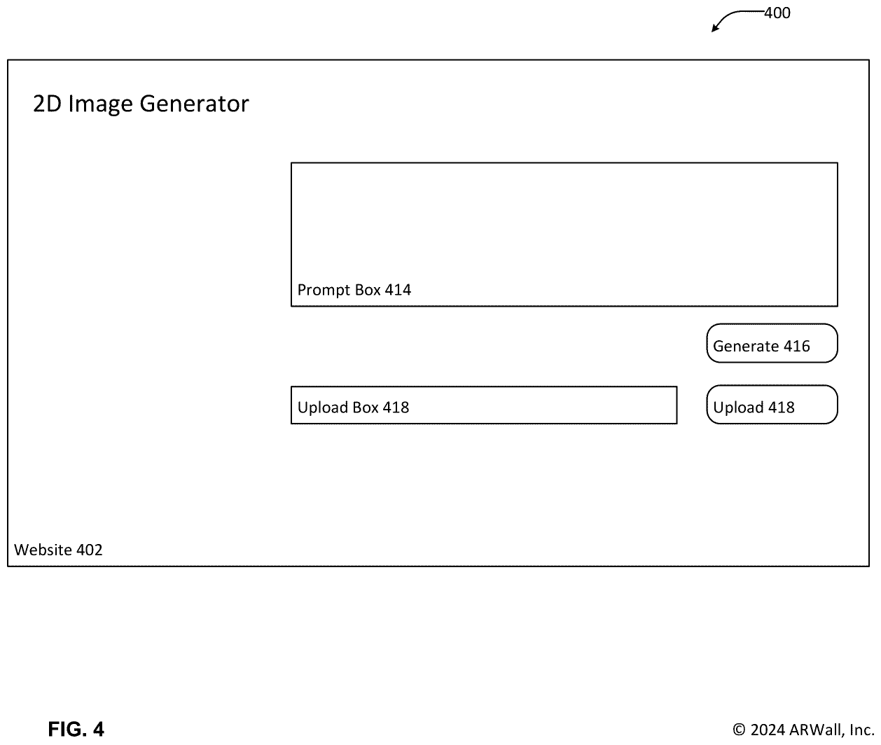

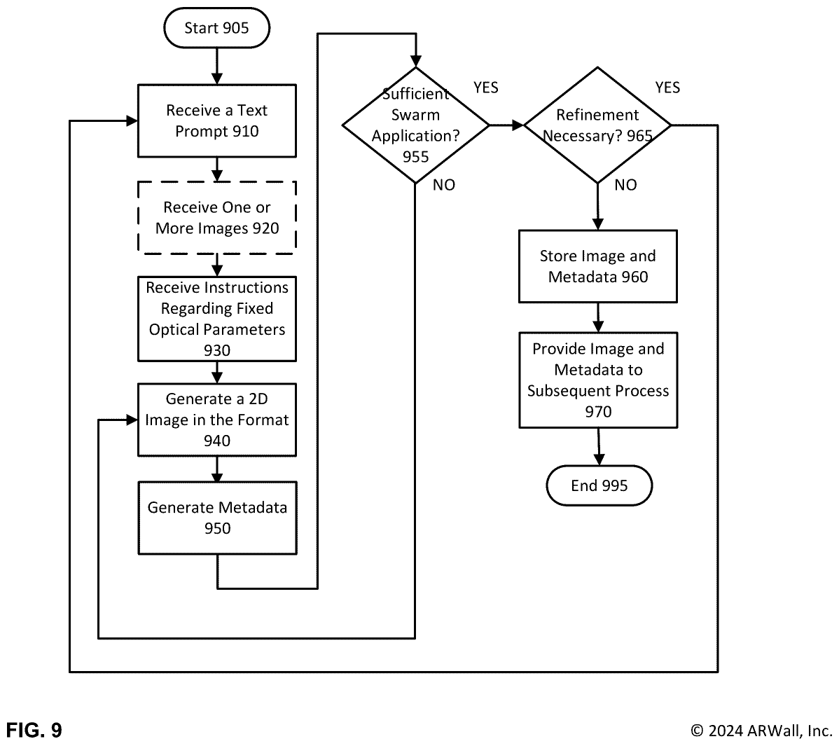

FIGS. 4, 5, 6, 7, and 8 will be discussed with reference to FIGS. 9, 10, 11, and 12 below.

Turning now to FIG. 9, a flowchart of a process two-dimensional image generation is shown. FIG. 9 begins with a start 905 and ends at end 995. This process corresponds with steps taken by the text to image AI server 320 (FIG. 3) operation to perform its desired functions.

Following the start 905, the process begins with receipt of a text prompt at 910. The text prompt is a text-based input received either at the user computing device 350 and/or at the text to image AI server 320. The text-based prompt should describe the desired scene and its component elements (e.g. “a science fiction movie scene with an industrial feel, including a cityscape background, catwalks in the mid-ground, and a perilous, metal platform upon which foreground actors will appear to stand”). The more detail is present in the prompt, the better-able the generative AI will be to create the desired scene. The text-based prompt is shown as required while the following step is optional (shown in dashed lines). In some cases, either may optional or both may be required.

Next, the process optionally (shown in dashed lines) requires receipt of one or more images at 920 as examples of desired components or aspects or inspiration for the desired two-dimensional image. These images may be in any scale and unrelated. These input images may be put into a cloud-based storage solution accessible to the server 320 or may be directly uploaded to the server 320. The images may be examples of similar backgrounds or locations or “feels” for what a filmmaker desires. Or, the images may be objects (e.g. sunglasses, or tables, or wall coverings, or cars, or rugs, or various other elements of a scene) that may be used as examples or similar to desired elements to make up the scene.

FIG. 4 is an example display screen of a two-dimensional image generator. FIG. 4 is an example user interface 400 for accepting text-based prompt and any input images. This is merely an example of such a user interface 400. Many other examples are possible. In this example, a website 402 is presented as the two-dimensional image generator, but custom applications or other mechanisms are possible.

The website 402 includes a prompt box 414 wherein a user can input a text-based prompt as described in step 910. Upload box 418 can be used to upload one or more images as discussed in step 920. The upload button 418 may cause the upload to occur or the identification of an appropriate cloud-based storage location. The generate button 416 will be relevant to begin the generation process at step 940, discussed below, but will result in using the input, text and/or images, to generate images and metadata as described below.

Next, the server 320 receives instructions regarding fixed optical parameters at 930. This step may occur once or may be updated each time the server 320 operates to create images as described herein. The server 320 is provide parameters to arrange various objects as is desirable for their subsequent use by server 330 to create a three-dimensional environment. So, for example, the characteristics of the output images which may be provided as instructions may include:

A requirement that the output images provide a one-hundred eight (180) degree field of view (for example, in cinema a 10 mm lens is used and the image created should appear similarly in appearance. A requirement that the resulting image(s) be level to horizon (i.e. not tilted/yawed). A requirement that the resulting image(s) not contain any inky solid black areas or peaking white highlights or blurry areas. A requirement that the image have a “neutral look” color temperature that is ready to grade/LUT (look up table) in camera. A requirement that the images be approximately 8K in resolution (or similar). A requirement that the resulting images contain no noticeable “AI artifacts” so that they are unsuitable for cinematic usage. The images should be such that any objects therein are in a proper 1:1 spatial proportion to each other and to potential human actors placed in front of the image. And, the image(s) must be in appropriate spatial proportions and other characteristics of the imagery must be such that each enables the image to three-dimensional AI server 330 to operate to create a corresponding scale three-dimensional environment.

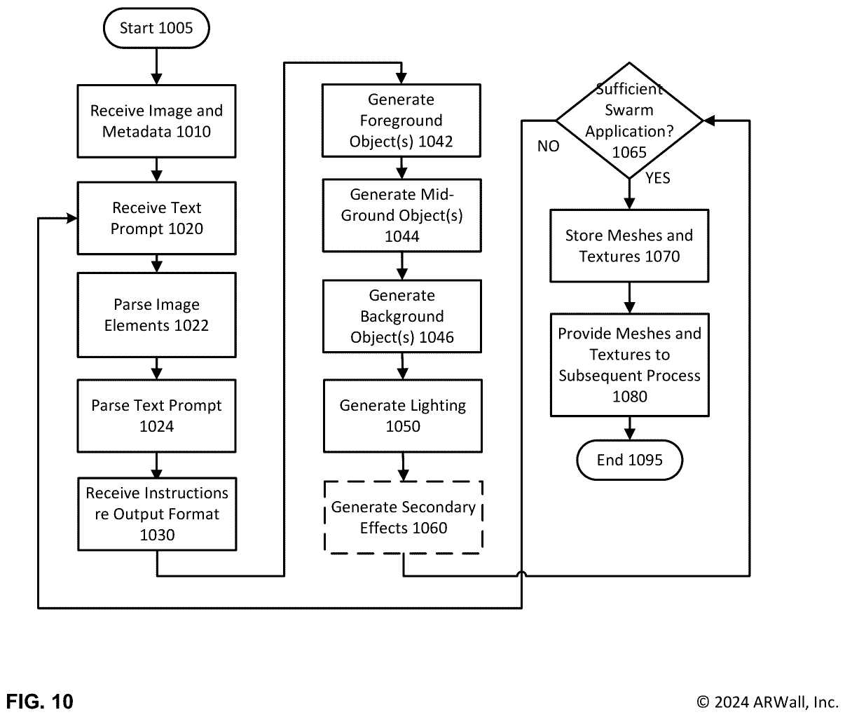

As a part of this step the prompt and/or images themselves may also be wrapped (e.g. in a more-detailed wrapper or prompt) to instruct generative AI in creating an image or images having the desired formatting discussed above. Those instructions may also be received (e.g. the wrapper for the prompt or the plugin used to generate the wrapped prompt) simultaneously with the instructions regarding the desired optical parameters at 930. In addition, the instructions may include a request to identify in the form of a known-format of metadata the characteristics and/or objects within the resulting image that is created so that they may be more-easily identified by the image to three-dimensional AI server 330 for the processes described in FIG. 10.

Next, the server 320 requests generative AI to generate a two-dimensional image in the desired format at 940. This may be initiated by the generate button 416 (FIG. 4) or may be initiated by the production management server 315 (FIG. 3) management software 315 in cases in which the process is largely automated. The generative AI operates to generate one or more suitable images having the desired characteristics at 940. Simultaneously or substantially simultaneously, the generative AI system may generate the metadata at 950 that identifies the scene, objects within the scene, and potentially their locations or placements in the scene for use by the image to three-dimensional server 330 with reference to FIG. 10.

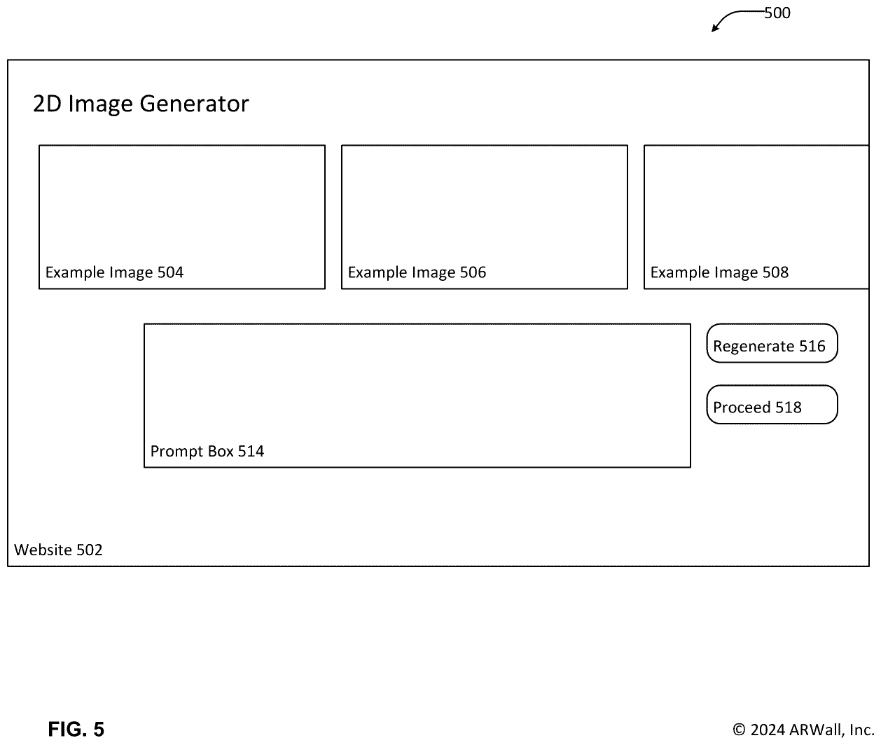

FIG. 5 is an example display screen of a two-dimensional image generator. Here, the results of the generation process may be seen at FIG. 5. The same user interface 500 is shown as a website 502. There are a plurality of example images 504, 506, and 508. Prompt box 514 remains to enable a user to input changes to the prompt and/or additions to the prompt to request changes to one or more of the example images 504, 506, or 508. Also, regenerate button 516 can be used to enable a user to act upon the additional text prompt while the proceed button 518 may be used to proceed to the next process shown in FIG. 10. Where much of this process is automated, no user interface (e.g. FIGS. 4-8) may be shown to users or only the initial generate interface (e.g. FIG. 4) may be shown with the rest of the process automated through to completion. In such a case, a proceed button 518 may be unnecessary entirely. And, here, three example images 504, 506, and 508 are shown, but many more may be generated or merely one may be generated, depending on the implementation.

Returning to FIG. 9, the process next proceeds to a query whether there has been sufficient application of swarm agents at 955. In some cases, none may be desired (e.g. only a single iteration), while in others, many swarm agents performing the function many times iteratively or in parallel may be desirable. If the answer is that insufficient application has been made (“no” at 955), then the process may continue with further generation of two-dimensional images and metadata at 940 and 950 until the determination is met.

After there is sufficient application of swarm agents to the requested process (“yes” at 955), then the process may check to determine if further refinement is necessary at 965. This may rely upon the regenerate button 518 shown in FIG. 5 and any refining text input into the associated prompt box 514. If refinement is necessary (“yes” at 965), then the process returns to receipt of the text in prompt box at 910 and the process continues from there through further refinement.

If no further refinement is necessary (“no” at 965), then the process continues with storage of the images and metadata at 960. Here, the images created by the server 320 (FIG. 3) are stored in image storage 328 along with the associated metadata discussed above.

Next, the image and metadata are provided (either automatically or through use of the proceed button 518) to the subsequent process (e.g. the process of FIG. 10) at 970. The resulting image and metadata are in such a form that it may be readily used by the subsequent process to generate a three-dimensional environment therefrom with proper scale to humans.

FIG. 10 is a flowchart of a process for three-dimensional mesh and texture generation. Turning now to FIG. 10, a flowchart of a process two-dimensional image generation is shown. FIG. 10 begins with a start 1005 and ends at end 1095.

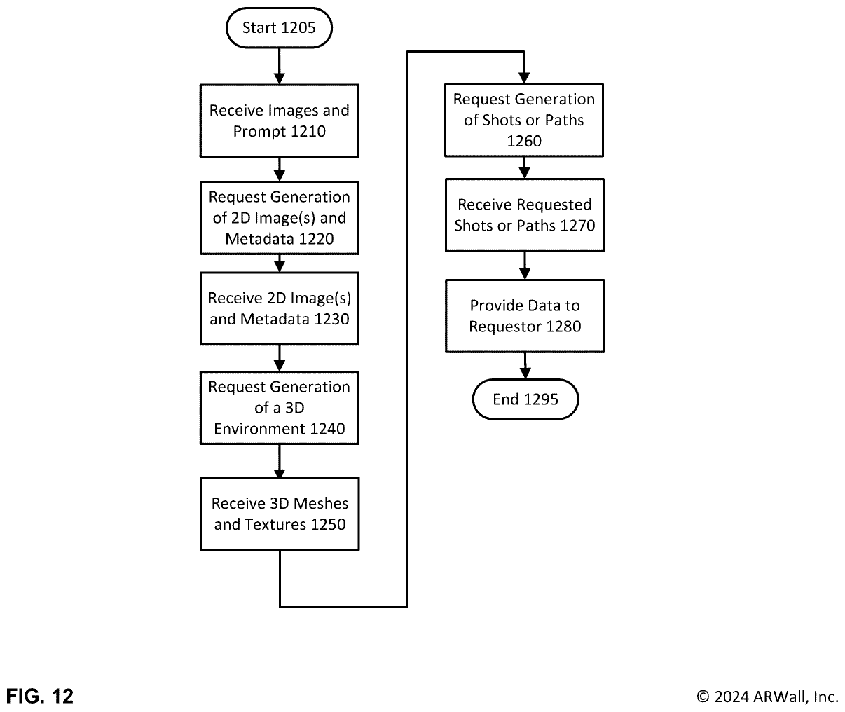

Following the start 1005, the process begins with receipt of image and metadata at 1010. This is the image and metadata that were generated in FIG. 9 and then passed for subsequent processing at step 970. The various servers 320, 330, and 340 are designed to act as an integrated whole to perform the functions described herein, so the processes of FIGS. 9-11 are likewise integrated with FIG. 12 operating as an optional overseer process for all three processes.

After receipt of the images and metadata at 1010, a text prompt may be received at 1020. The text prompt received may be optional in some cases, as the process may be fully automatic. Any such text prompt directs the server 330 (FIG. 3) as to how to utilize the two-dimensional images and metadata (e.g. a perspective) or anything that is desired to be added to or tweaked in the scene. Preferably, this process occurs in FIG. 9 with refinement to the two-dimensional image and metadata, but it is also possible as this stage in some cases.

The process continues with parsing the image elements at 1022. At this step, both the image and metadata are reviewed by the server 330 (FIG. 3) to enable it to generate associated three-dimensional environment. The metadata may be used to help identify elements and their relative location and/or importance (e.g. foreground objects versus mid-ground objects, versus background objects and skybox, and any lighting and its locations).

Next, the text prompt may be parsed at 1024 to determine if there is any revision or particular elements of the desired three-dimensional environment to be created. For example, a user may input a prompt that is as simple as wishing to have a virtual camera placed at a particular location within the shot (e.g. left, center) or may request alteration of the lighting in the example image to move it from behind the camera to left of camera. A user could request a different color or location for an object shown in the scene or that still other objects be added to the scene or the like. Other instructions are possible to be present in the text prompt.

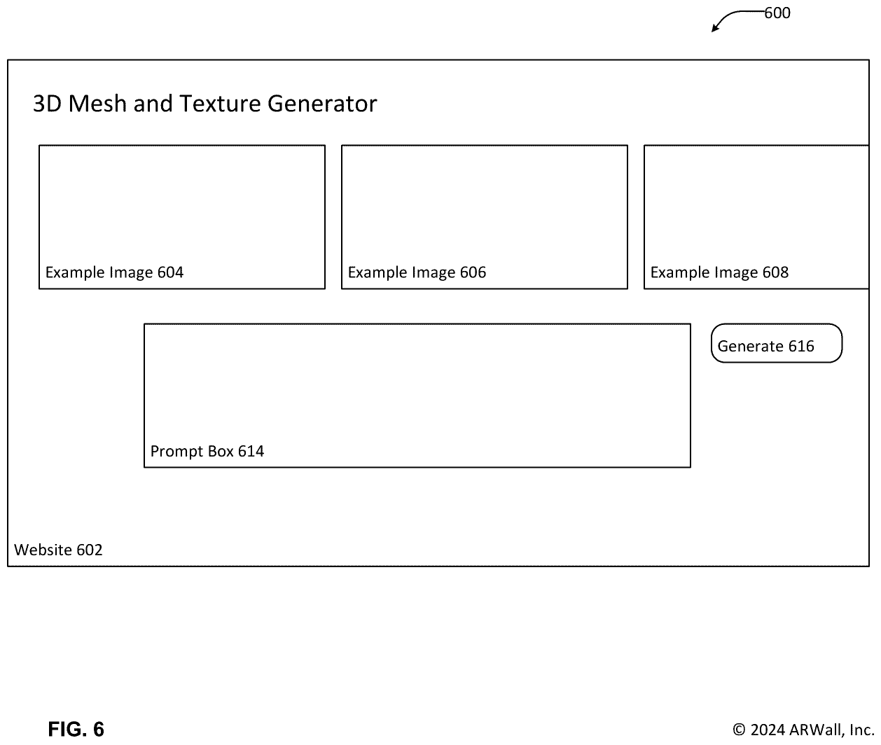

FIG. 6 is an example of a display screen for a three-dimensional mesh and texture generator. This is an example of a user interface 600 that may be implemented as a website 602. The website 602 may have the plurality of selected images 604, 606, and 608 that were identified as suitable for creation of a three-dimensional environment therefrom. The prompt box 614 may enable the user to input a prompt as described at 1020. Thereafter, a user may select the generate button 616 to begin creation of the associated three-dimensional environment.

After the automated process continues or after receipt of interaction with the generate button 616, the process continues in FIG. 10 with generation of foreground object(s) at 1042. Here, high-resolution textures are generated along with high-resolution meshes for objects that will be present in the foreground because they will be closest to a virtual camera. The metadata may assist in this process by specifically identifying locations of foreground objects as “close” to the camera or the images themselves may be parsed to separately identify and flag certain objects as foreground objects. Two different pieces of generative AI software may be used to create the meshes and the associated textures or only one may be employed.

Next, the mid-ground object(s) are generated at 1044. Here, lower-quality textures and meshes may be used because these objects are less-close to a virtual camera that may film this object and location.

Next, background object(s) may be generated at 1046. Here a skybox (e.g. a single image that fills all or part of a sky at an indeterminate depth that is the “sky” may be used alone or in addition to very distant objects which may be shown as merely two-dimensional images positioned within an otherwise three-dimensional environment with an accompanying two-dimensional texture. Or, simplified three-dimensional models may be used. In either case, the desire is to lower computational requirements and enable the system to present depth of field to a viewer from the prospective virtual camera location.

Next, lighting effects are generated at 1050. As discussed above, these effects may be hard-coded into the textures themselves, particularly at mid and background levels of depth. Or, the lighting may be dynamic, generated by the three-dimensional engine in real-time based upon placement of a virtual “sun” or other light source(s) within the prospective three-dimensional environment. Most game engines or similar software have integrated capability for adding light sources, but hard-coded lighting may be more resource efficient in some cases.

The process then continues with the application of secondary effects at 1060. Here, particle effects, non-rigid physics effects, smoke, water, and the like can be added or certain elements of the three-dimensional environment may be flagged as non-rigid to provide movement at various depths within the scene. This process, like the others, may be aided by the metadata associated with the elements present in the two-dimensional image(s).

Next, a determination is made whether the swarm agents' application has been sufficient at 1065. As discussed above, swarm agents may provide an avenue to brute force or to iteratively or in parallel to generate many options for the three-dimensional environment and to thereafter select the best-suited or most-appropriate. This process may be fully or partially autonomous or may be manual wherein a user selects from among a group of options.

If further application of swarm agents is needed (“no” at 1065), then the process may return to 1020 for the generation of additional three-dimensional environments or revisions thereto.

If the process is completed regarding swarm agents' application (“yes” at 1065), then process continues with storage of the meshes and textures at 1070. Here, lighting effects, particle effects, and any additional metadata are also stored.

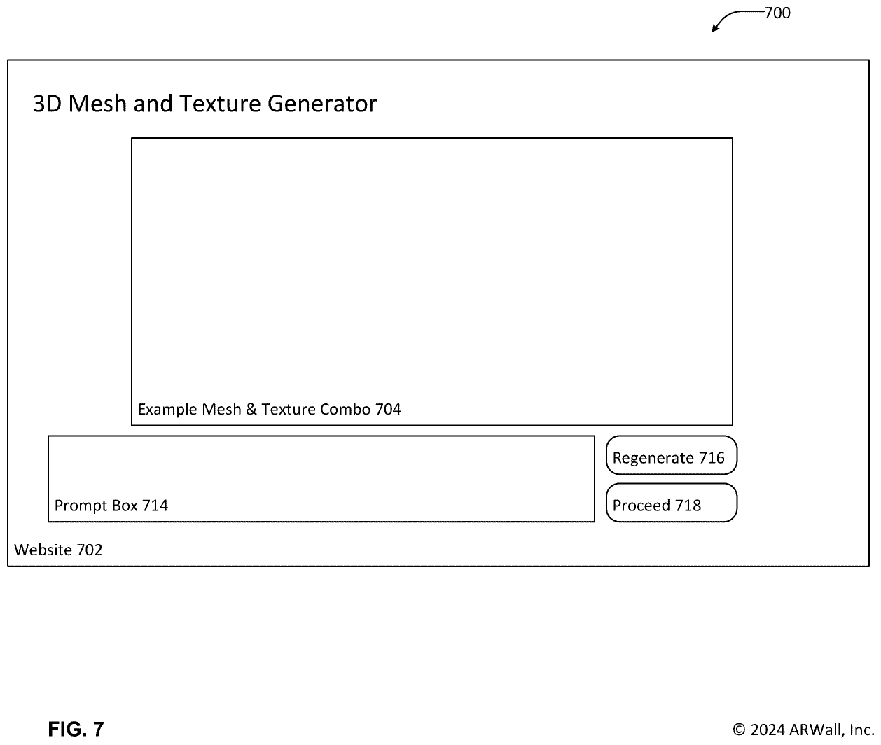

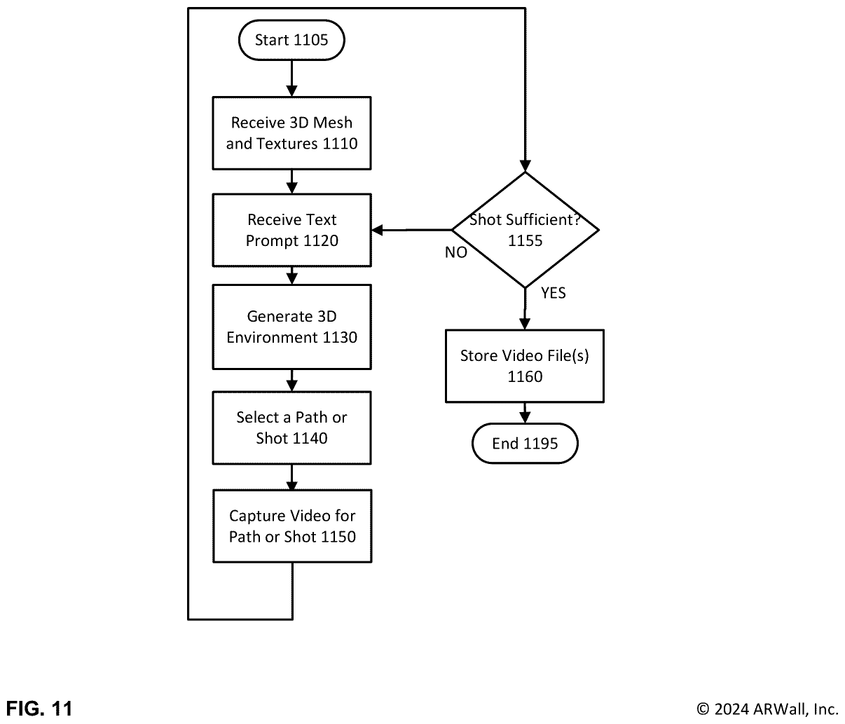

FIG. 7 is an example of a display screen for a three-dimensional mesh and texture generator. Here, the user interface 700 remains at website 702. An example mesh and texture combination is shown in preview 704 which may be a three-dimensional environment viewing screen or preview screen operating within a three-dimensional game engine or similar computer software. A prompt box 714 may be presented to enable a user to input further changes or requested changes. Thereafter the user may request regeneration using the regenerate button 716. Or, the process may use the proceed button 718 to pass the example mesh and texture combination shown in the preview 704 to the next server 330 and process (FIG. 11). And, just as with all of FIGS. 4-8, they are merely examples which may be implemented in various forms.

Returning to FIG. 10, the meshes and textures are provided to the subsequent process (FIG. 11) at 1080. Because the servers 320, 330, 340 are designed to work together on the overall process (FIG. 12), they may be integrated so as to incorporate APIs for passing data and inputs and outputs among one another to easily transition through each process to a desired output.

FIG. 11 is a flowchart of a process for video generation. Turning now to FIG. 11, a flowchart of a process two-dimensional image generation is shown. FIG. 11 begins with a start 1105 and ends at end 1195.

Following the start 1105, the process begins with receipt of the three-dimensional mesh and textures at 1110. Here, the mesh and textures created in the preceding process (FIG. 10) are provided to the three-dimensional to video server 340. The three-dimensional environment that is created using these meshes and textures can be used to generate the desired shot or shots in the same environment or built-upon the environment. The output of the preceding process (FIG. 10) may be formatted for easy use by this process in creating such shots.

Next, a text-based prompt may be received at 1020. Here, a user may indicate the type of shot(s) that are desired. For example, a request may include an establishing shot, a master shot, and a fly-by shot of a particular three-dimensional environment. The user may input such information at this step 1120.

Next the three-dimensional environment may be generated at 1130. This process involves the use of the meshes, textures, lighting, particle effects, and any other elements created in the preceding process to generate the environment so that associated shots may be filmed therein or related thereto.

In some cases, the actual three-dimensional environment may not be sufficient for a shot. For example, the generated assets may not be suitable for an exterior establishing shot (e.g. that the actors are present in a particular home). In such cases, the process of generating the three-dimensional environment at 1130 may involve extrapolation of what the exterior of a home or apartment or space lab or haunted house or the like will look. That type of environment may be created on the fly. Or, alternatively, the entirety of processes shown in FIGS. 9-11 may take place again for any locations or three-dimensional environments not present in the mesh and textures provided at 1110. A user may be prompted to perform that task or it may begin autonomously when needed.

Thereafter, the prompt maybe parsed to select a path or shot at 1140. So, for example, if a prompt is “an exterior establishing shot for a character's home,” then the selected shot may be an across-the-street baseline, level shot or angled shot of an exterior residence. If the prompt is “a tracking shot moving across this scene for 45 seconds following characters as they move,” then the path selected may follow that designation and may require timing and placement of the camera to identify that shot and to flow therethrough along a path selected by generative AI.

Next, the path selected is captured as video from a perspective selected by generative AI at 1150. Here, the camera pans along the desired path or sits in the desired position to capture the requested shot as described by the prompt.

A determination is made at 1155 whether the shot is sufficient. This may be manual (e.g. a user may decide yes or no) or it may be automated using the production management server 315. The user or system should identify whether the prompt has been adequately met by the shot generated at 1150. More than one shot may be included in the prompt and in this determination.

If not (“no” at 1155), then the process begins again at receipt of the text prompt at 1120. If so (“yes” at 1155), then the process continues with storage of the resulting video file(s). And, the process ends at 1195.

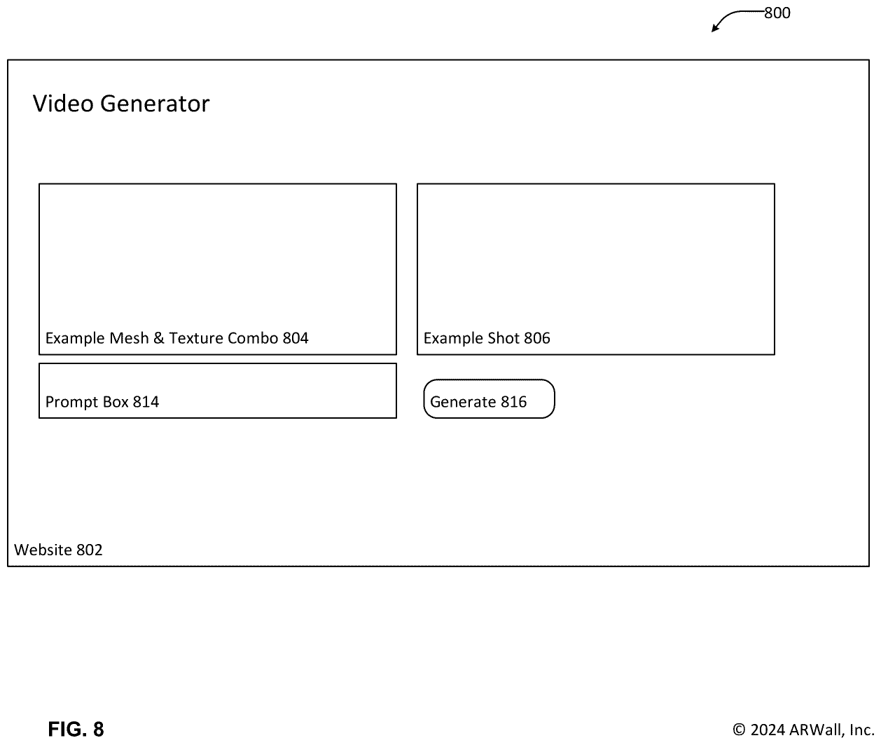

FIG. 8 is an example of a display screen for a video generator. This may be used for input of the prompt and review of the three-dimensional environment that is to be used. Here the user interface 800 is again a website 802. There is a preview of the mesh and texture combination 804 along with prompt box 814 for inputting any instructions related to the shot to be created. Once the process has begun, an example shot maybe shown in preview 806. The option to generate 816 or re-generate with a new prompt or different mesh and texture combo is enabled by the generate button 816.

FIG. 12 is a flowchart of a process for artificial intelligence augmented virtual film production. Turning now to FIG. 12, a flowchart of a process two-dimensional image generation is shown. FIG. 12 begins with a start 1205 and ends at end 1295. This process is the process that may be implemented by the production management server 314 (FIG. 3) to oversee the overall process of FIGS. 9-11. This may be the process in some cases. Or, in other cases, the system may be designed in such a way that it is tightly-integrated with each subsequent process of FIGS. 9-11 reliant upon and expecting the output of the preceding process.

Following the start 1205, the process begins with receipt of images and any text-based prompt from a user at 1210. Here may be the only input from a user directing the overall system to create a certain three-dimensional environment and associated shots in video form.

Thereafter, generation of one or more two-dimensional images at metadata may be requested by the production management server 315 at 1220. These may be generated following the process of FIG. 9. In response, the two-dimensional image(s) and metadata are received at 1230 by the production management server 315 and/or by the image to three-dimensional AI server 330.

Next, the production management server 315 may request generation of a three-dimensional environment at 1240. This may follow the process described in FIG. 10. Thereafter, the output is the three-dimensional meshes and textures (and lighting, etc.) are received at 1250. This receipt may be by the production management server 315 and/or the three-dimensional to video server 340.

Next, the production management server 315 may request generation of shots or paths according to the original prompt at 1260. The process of FIG. 11 takes place in response. Then, the requested shots or paths are received at 1270.

Thereafter, the three-dimensional environment in the form of meshes and textures and any shots or paths are provided as data to the requestor at 1280. And, thereafter, the process ends.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system comprising:
a computer for
receiving a text-based prompt from a user along with one or more images of a desired virtual location; and
outputting a two-dimensional image representative of the desired virtual location, the two-dimensional image incorporating fixed optical parameters and associated metadata identifying at least two objects within the two-dimensional image;
a second computer for
receiving the two-dimensional image and the associated metadata; and
outputting a three-dimensional environment, including a three-dimensional mesh for objects within the three-dimensional environment, associated textures for the objects, and an associated lighting map for the three-dimensional environment; and
a third computer for
receiving the three-dimensional environment and a second text-based prompt from a second user providing instructions for a particular type of video to be created; and
outputting a video within the three-dimensional environment corresponding to the three-dimensional environment.

2. The system of claim 1 wherein at least two of the first, second, and third computers are one computer.

3. The system of claim 1 wherein the second computer is further for:
generating certain objects as foreground objects at an appropriate foreground scale that is realistically accurate relative to an average human within the three-dimensional environment;
generating other objects as mid-ground objects at an appropriate mid-ground scale relative to the foreground scale of the foreground objects; and
generating still other objects as background objects at an appropriate background scale from a perspective on the three-dimensional environment sufficient to provide realistic depth to a scene shown in the three-dimensional environment.

4. The system of claim 3 wherein the second computer is further for generating the three-dimensional environment in a form suitable for capture by a film camera, a perspective on the three-dimensional environment including at least a one-hundred-and-eighty-degree view of the three-dimensional environment.

5. The system of claim 3 wherein the second computer further generates a selected one of particle effects, fluid effects, weather, or non-rigid environmental effects for the three-dimensional environment.

6. The system of claim 1 wherein each of the first computer, the second computer, and the third computer utilize swarm agents to repeatedly perform each output process a plurality of times to generate many options.

7. The system of claim 6 further comprising a fourth computer for receiving each result of the outputting steps generated by the swarm agents and selecting a result that best matches the text-based prompt and the one or more images and the second text-based prompt.

8. An apparatus comprising non-volatile machine-readable medium storing a program having instructions which when executed by a processor will cause the processor to:
receive a text-based prompt from a user along with one or more images of a desired virtual location;
output a two-dimensional image representative of the desired virtual location, the two-dimensional image incorporating fixed optical parameters and associated metadata identifying at least two objects within the two-dimensional image;
receive the two-dimensional image and the associated metadata;
output a three-dimensional environment, including a three-dimensional mesh for objects within the three-dimensional environment, associated textures for the objects, and an associated lighting map for the three-dimensional environment;
receive the three-dimensional environment and a second text-based prompt from a second user providing instructions for a particular type of video to be created; and
output a video within the three-dimensional environment corresponding to the three-dimensional environment.

9. The apparatus of claim 8 wherein the instructions further cause the processor to:
generate certain objects as foreground objects at an appropriate foreground scale that is realistically accurate relative to an average human within the three-dimensional environment;
generate other objects as mid-ground objects at an appropriate mid-ground scale relative to the foreground scale of the foreground objects; and
generate still other objects as background objects at an appropriate background scale from a perspective on the three-dimensional environment sufficient to provide realistic depth to a scene shown in the three-dimensional environment.

10. The apparatus of claim 9 wherein the three-dimensional environment is generated in a form suitable for capture by a film camera, a perspective on the three-dimensional environment including at least a one-hundred-and-eighty-degree view of the three-dimensional environment.

11. The apparatus of claim 9 wherein the processor is further instructed to generate a selected one of particle effects, fluid effects, weather, or non-rigid environmental effects for the three-dimensional environment.

12. The apparatus of claim 8 wherein the instructions further cause the processor to utilize swarm agents to repeatedly perform each output process and generate a plurality of options for each.

13. The apparatus of claim 12 wherein the processor is further instructed to receive each result of the output process generated by the swarm agents and select a result that best matches the text-based prompt and the one or more images and the second text-based prompt.

14. The apparatus of claim 8 further comprising:
the processor;
a memory;
wherein the processor and the memory comprise circuits and software for performing the instructions on the storage medium.

15. A method for enabling filming using a real-time display, the method comprising:
receiving a text-based prompt from a user along with one or more images of a desired virtual location;
outputting a two-dimensional image representative of the desired virtual location, the two-dimensional image incorporating fixed optical parameters and associated metadata identifying at least two objects within the two-dimensional image;
receiving the two-dimensional image and the associated metadata;
outputting a three-dimensional environment, including a three-dimensional mesh for objects within the three-dimensional environment, associated textures for the objects, and an associated lighting map for the three-dimensional environment;
receiving the three-dimensional environment and a second text-based prompt from a second user providing instructions for a particular type of video to be created; and
outputting a video within the three-dimensional environment corresponding to the three-dimensional environment.

16. The method of claim 15 further comprising:
generating certain objects as foreground objects at an appropriate foreground scale that is realistically accurate relative to an average human within the three-dimensional environment;
generating other objects as mid-ground objects at an appropriate mid-ground scale relative to the foreground scale of the foreground objects; and
generating still other objects as background objects at an appropriate background scale from a perspective on the three-dimensional environment sufficient to provide realistic depth to a scene shown in the three-dimensional environment.

17. The method of claim 16 wherein the three-dimensional environment is generated in a form suitable for capture by a film camera, a perspective on the three-dimensional environment including at least a one-hundred-and-eighty-degree view of the three-dimensional environment.

18. The method of claim 16 further comprising generating a selected one of particle effects, fluid effects, weather, or non-rigid environmental effects for the three-dimensional environment.

19. The method of claim 18 further comprising utilizing swarm agents to repeatedly perform each output process and generate a plurality of options for each.

20. The method of claim 18 further comprising receiving each result of the output process generated by the swarm agents and selecting a result that best matches the text-based prompt and the one or more images and the second text-based prompt.
